(19) United States
(12) Patent Application Publication
(10) Pub. No.: US 2025/0215308 A1
(43) Pub. Date: Jul. 3, 2025

(54) TREATMENT FLUIDS HAVING OIL-SOLUBLE DRAG REDUCING AGENTS FOR WELLBORE OPERATIONS

(71) Applicant: Jian Zhou, Magnolia, TX (US)

(72) Inventor: Jian Zhou, Magnolia, TX (US)

(21) Appl. No.: 18/986,827

(22) Filed: Dec. 19, 2024

Related U.S. Application Data
(60) Provisional application No. 63/615,183, filed on Dec. 27, 2023.

(51) Int. Cl. C09K 8/74; C09K 8/72

(52) U.S. Cl. CPC C09K 8/74; C09K 8/725; C09K 2208/30

(57) ABSTRACT

A treatment fluid for oilfield applications, such as matrix acidizing and acid fracturing. The treatment fluid is a two-phase fluid with an hydrophobic continuous phase and an at least partially dispersed water phase. The hydrophobic continuous phase can contain 1 ppm to 10 wt %, based on the total weight of the treatment fluid, of one or more types of oil-soluble DRAs having a weight average molecular weight greater than 200,000. The at least partially dispersed water phase can contain water and one or more reactive acids having a pH of 4 or less than 4.

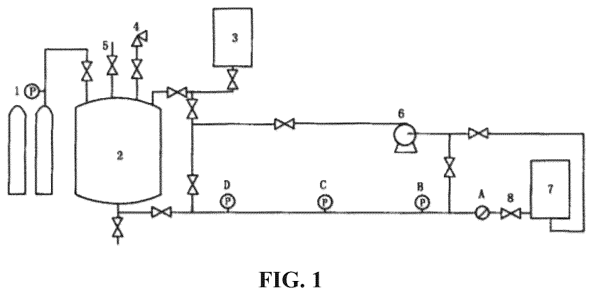

### TECHNICAL FIELD

Embodiments of the present invention generally relate to treatment fluids having oil-soluble drag reducing agents (DRAs) for wellbore operations. More particularly, embodiments of the present invention generally relate to water and oil two-phase fluids having oil-soluble drag reducing agents (DRAs) for wellbore operations.

### BACKGROUND

Crude oil and natural gas are produced from a subterranean formation, sometimes referred to as a reservoir. To produce oil and gas from a reservoir, a wellbore is connected to a reservoir through a drilling and completion process. Once the well is completed, stimulation treatments such as fracturing, matrix acidizing, and acid fracturing can be used to reduce reservoir damage and to enhance the hydrocarbon recovery from the reservoir.

A fracturing process involves injecting high viscosity treatment fluid through the wellbore and into the formation at pressures sufficient to fracture the formation, and then placing sand particles (or proppants) in the fracture to keep it open once the operation is complete. This process creates a large flow channel through which hydrocarbons can more readily move from the formation to the wellbore.

Matrix acidizing is another type of oilfield stimulation treatment. Inorganic acids, organic acids, or chelates containing treatment fluid is injected downhole and reacts with carbonate formations. The reaction dissolves and removes carbonate formations from the reservoir, leaving new flow channels for oil and gas to flow. Other acid treatments involve removing blocking materials and restoring the permeability for oil and gas production. Water-soluble friction reducers are one of the common additives in treatment fluid, so the fluid could be pumped at a higher rate.

The acid fracturing process involves the injection of acids at a high pressure sufficient enough to fracture the reservoir, the dissolution of a small portion of reservoir rock to create an uneven surface, and the creation of a new larger surface area for oil and gas to flow.

During such aforementioned stimulation processes, treatment fluid is pumped through the wellbore at a very high rate, typically in a turbulent flow regime. The turbulence is measured by Reynolds number (Re), and it is typically higher than 4,000. Higher turbulence consumes more energy, and a bigger pressure difference is created between surface pumping equipment and downhole treatment zone. Due to limitations of the wellbore and mechanical strength of the pumping equipment, there is an upper limit on how much pressure the operation can handle, thus limiting the treatment fluid flow rate. Water-soluble friction reducers are typically used to reduce the turbulence, thus significantly reducing the pressure on the wellbore and achieving higher flow rates.

Water-soluble polymeric compositions have been used over the years to reduce drag in water-based treatment fluids during fracturing and matrix acidizing processes. For example, guar and derivatized guar with different molecular modification, polyacrylamide and its derivatives with cationic, anionic or nonionic groups, polyethyleneoxide, and other high molecular weight water-soluble synthetic polymers have been used to reduce friction pressures. Currently, the industry standard for friction reduction in the oilfield is to use water-soluble polymers such as polyacrylamide and its derivatives in the forms of a powder, solid in oil slurry, water-based emulsion, or an inverted emulsion. For example, U.S. Pat. No. 9,034,802 discloses fluids with low friction pressures for well service applications such as fracturing, gravel packing, well clean-out, acidizing matrix and acid fracturing treatments and the like, and methods for their use. The drag reducing polymers disclosed are Guar, polymethylmethacrylate, polyethyleneoxide, polyacrylamide, polyAMPS (poly 2-acrylamido-2-methylpropane sulfonic acid), polymers derived therefrom. U.S. Pat. No. 3,442,803 discloses a copolymer of acrylamide and methylene bis-acrylamide. Such friction reducers (FR) can decrease frictional pressure losses and improve effectiveness of fracturing operations by allowing for higher fracturing (frac) injection rates at the same or lower surface pressures. By optimizing FR selection for field application, cost savings can be realized through reduction in chemical costs, reduction in equipment maintenance frequency, and rental savings.

Deeper penetration of acid is desirable to create better flow channels for oil and gas to flow. The reaction rate between acids and carbonate reservoir rock increases with the increase of reservoir temperature. Once the temperature gets above 250° F., straight acid-in-water treatment fluid will only result in the dissolution of rock closest to the wellbore. To slow down the reaction between the acid and reservoir rock, an acid emulsion (acid-in-oil emulsion) based acidizing fluid is used. The acid in the water phase has to diffuse through oil to reach the surface of the carbonate reservoir, which significantly reduces the reaction rate. This allows more acid to travel deeper into the reservoir and achieve further radial penetration. In addition, because acid is not in direct contact with the metal surface of equipment and the wellbore, the corrosion to these surfaces can be significantly reduced. It is the same situation for acid fracturing treatment. With a slower reaction between acid and reservoir, acid can travel further into the reservoir, creating bigger surface area for oil and gas to flow.

Usage of acid-in-oil emulsions for matrix acidizing and acid fracturing treatments for high temperature wells have several limitations: (1) For deeper wells, the treatment fluid has to flow through a longer wellbore at a high flow rate, and the energy loss from turbulent flow regimes in the wellbore limits the flow rate of the fluid; (2) Treatment effectiveness is limited—The chemical reaction rate between treatment fluid and reservoir rock increases with higher reservoir temperature, so more acid will react with rock in the near-wellbore region. This results in less acid to treat further regions, thus limiting the depth of treatment; and (3) The corrosion rate of the wellbore by the treatment fluids increases with higher temperature.

Conventional drag reducing materials have focused on water-soluble polymers for aqueous treatment fluids and drag reducing agents for crude oil transportation. These conventional water-soluble polyacrylamide types can be used to reduce friction pressure of a water-based treatment fluid during a downhole treatment process. However, due to the insolubility of such water-soluble polymers in hydrocarbons, a more effective solution for an emulsion based treatment fluid is needed.

### SUMMARY

Treatment fluids for various oilfield applications, such as matrix acidizing and acid fracturing, are provided herein. The treatment fluid can be a two-phase fluid with an hydrophobic continuous phase and an at least partially dispersed water phase. The hydrophobic continuous phase can contain 1 ppm to 10 wt %, based on the total weight of the treatment fluid, of one or more types of oil-soluble DRAs having a weight average molecular weight (Mw) of greater than 200,000. The at least partially dispersed water phase can contain water and one or more reactive acids having a pH of 4 or less or less than 4.

### BRIEF DESCRIPTION OF THE DRAWING

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein. It is to be noted, however, that the appended drawings illustrate only typical embodiments of this invention and are, therefore, not to be considered limiting of its scope, for the invention may admit to other equally effective embodiments. It is also emphasized that the figures are not necessarily to scale and certain features and certain views of the figures can be shown exaggerated in scale or in schematic for clarity and/or conciseness.

The FIG. is a simplified flow diagram of a mixing process for making and testing the DRA water-in-oil emulsion, according to one or more embodiments provided herein.

### DETAILED DESCRIPTION

A more detailed description of the invention provided herein will now be provided. The present invention will be described in connection with numerous embodiments. Such discussion is for purposes of illustration only and not intended to be limitative of the invention. Modifications to particular embodiments within the spirit and scope of the present invention, set forth in the appended claims, will be readily apparent to those of skill in the art. Accordingly, it is to be understood that the following disclosure describes several exemplary embodiments for implementing different features, structures, or functions of the invention. Exemplary embodiments of components, arrangements, and configurations are described below to simplify the present disclosure; however, these exemplary embodiments are provided merely as examples and are not intended to limit the scope of the invention.

Additionally, certain terms are used throughout the following description and claims to refer to particular components. As one skilled in the art will appreciate, various entities can refer to the same component by different names, and as such, the naming convention for the elements described herein is not intended to limit the scope of the invention, unless otherwise specifically defined herein. Further, the naming convention used herein is not intended to distinguish between components that differ in name but not function.

Furthermore, in the following discussion and in the claims, the terms “including” and “comprising” are used in an open-ended fashion, and thus should be interpreted to mean “including, but not limited to.” The phrase “consisting essentially of” means that the described/claimed composition does not include any other components that will materially alter its properties by any more than 5% of that property, and in any case does not include any other component to a level greater than 3 mass %.

Unless otherwise indicated, all numerical values are “about” or “approximately” the indicated value, meaning the values take into account experimental error, machine tolerances and other variations that would be expected by a person having ordinary skill in the art. It should also be understood that the precise numerical values used in the specification and claims constitute specific embodiments. Efforts have been made to ensure the accuracy of the data in the examples. However, it should be understood that any measured data inherently contains a certain level of error due to the limitation of the technique and/or equipment used for making the measurement.

Moreover, certain embodiments and features will be described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated.

In the following discussion and in the claims, the singular forms “a”, “an”, and “the” are intended to include the plural forms as well, unless the context clearly indicates otherwise. Further, the terms “including” and “comprising” are used in an open-ended fashion, and thus should be interpreted to mean “including, but not limited to.” The phrase “consisting essentially of” means that the described/claimed composition does not include any other components that will materially alter its properties by any more than 5% of that property, and in any case, does not include any other component to a level greater than 3 wt %.

The term “or” is intended to encompass both exclusive and inclusive cases, i.e., “A or B” is intended to be synonymous with “at least one of A and B,” unless otherwise expressly specified herein.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Each of the appended claims defines a separate invention, which for infringement purposes is recognized as including equivalents to the various elements or limitations specified in the claims. Depending on the context, all references to the “invention” may in some cases refer to certain specific embodiments only. In other cases, it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions, when the information in this disclosure is combined with publicly available information and technology.

According to one or more embodiments of the present invention, one or more treatment fluids or compositions having an aqueous phase dispersed within a continuous hydrophobic phase are provided herein. Such treatment fluids or compositions can be considered an “emulsion”, which as that term is used herein, refers to a water or aqueous phase that is at least partially dispersed throughout and/or within a continuous oil or hydrocarbon phase that is hydrophobic. The oil or hydrocarbon of the oil/hydrocarbon phase can be the indigenous hydrocarbons from the wellbore being treated with the treatment fluids or compositions provided herein. In certain embodiments, the oil or hydrocarbon phase can be or can contain one or more hydrocarbons selected from NGLs, diesel, kerosin, crude oil condensates, petroleum distills, mineral oils, crude oil, and liquid paraffins.

In the treatment fluids or compositions provided herein, active water containing droplets (i.e. water droplets) are suspended in a continuous oil or hydrocarbon phase. Such treatment fluids or compositions have been found to significantly reduce friction pressure within a wellbore. Not wishing to be bound by theory, the treatment fluids or compositions provided herein are able to significantly reduces friction pressure when used in a wellbore because the friction pressure is believed to primarily come from friction between water droplets, not from friction within the water droplets. As such, decreased friction is obtained by reducing friction of the continuous oil or hydrocarbon phase.

The treatment fluids or compositions can take various forms, including powder, slurry in solvents, or gels. It has been recently discovered that the treatment fluids or compositions provided herein can significantly reduce the friction pressure or drag of hydrocarbons in a wellbore, resulting in faster and more effective treatment and significant energy savings. For example, the treatment fluids or compositions provided herein can reduce the friction from turbulent flow during a pumping process, as well as increase pumping rates of a treatment fluid.

The treatment fluids or compositions provided herein can increase the viscosity of the oil phase, which provides several advantages. For one, the increased viscosity can reduce the acid diffusion rate between the internal acid water droplets and the surrounding reservoir, thus decreasing the reaction rate between acid and reservoir rock. This enables the reactive acid to have a deeper reach into the reservoir. The reduction of the diffusion rate also decreases the reaction of acid with metal parts, and therefore reduces the corrosion rate on the wellbore and surface pumping equipment.

In one or more embodiments, the treatment fluids provided herein can provide reduced friction for an acid-in-hydrocarbon emulsion for matrix acidizing and acid fracturing. In one particular embodiment, a treatment fluid can be or can include a mixture of two or more oil-soluble DRAs. For example, two or more different oil-soluble DRAs can be used in selective amounts that are effective to reduce the drag of an acid-in-hydrocarbon emulsion for matrix acidizing and acid fracturing. In another particular embodiment, the treatment fluid can have a continuous phase containing one or more hydrocarbons and one or more oil-soluble DRAs, and a water dispersed phase containing water and one or more water-soluble reactive acids.

Suitable oil-soluble DRAs can include, for example, long chain, high molecular weight, oil-soluble polymeric hydrocarbons. The DRA can have a weight average molecular weight (Mw) between 1 million and 100 million. The DRA can be linear or branched.

The DRAs can be a powder. The DRA powder can have an average particle size less than 1 cm, alternatively less than 1 mm, and in another embodiment below 100 microns.

The DRAs can be added to oilfield treatment fluid in a powder suspension in polar solvent form. The DRA can be in solid powder suspension in one or more polar solvents, or an emulsion form with the droplet containing DRA concentrate dispersed in one or more polar solvents. Useful polar solvents can be, but not limited to, one or more alcohols with different chain lengths, such as glycols, glycerol, ketones, water or brines. The formulation can contain a dispersed phase with DRA between 10% to 70%, with 30% to 40% preferred. A surfactant, weighting agent, water-soluble viscosifier also can be added to further stabilize the suspensions in the formulations.

The DRA can be a polymer concentrate in a hydrophobic solvent. Useful hydrophobic solvents can be linear or branched, saturated or unsaturated hydrocarbons, or aromatics, or esters, etc. The concentrate can contain up to 0.01% to 20% active DRA polymer.

In one or more specific embodiments, the DRA can be in the form of a latex drag reducer comprising a high molecular weight polymer dispersed in an aqueous continuous phase. The latex drag reducer can be prepared via emulsion polymerization of a reaction mixture comprising one or more monomers, a continuous phase, at least one surfactant, and an initiation system. The continuous phase generally comprises at least one component selected from the group consisting of water, polar organic liquids, and mixtures thereof. When water is the selected constituent of the continuous phase, the reaction mixture can also comprise a buffer. Additionally, as described in more detail below, the continuous phase can optionally comprise a hydrate inhibitor. In another embodiment, the DRA can be in the form of a suspension or solution according to any method known in the art.

In at least one specific embodiment, the DRA can have repeating units of C4-C20 alkyl, C6-C20 substituted or unsubstituted aryl, or aryl-substituted C₁-C₁₀ alkyl ester derivatives of methacrylic acid or acrylic acid. In another embodiment, the DRA can be a copolymer comprising repeating units of 2-ethylhexyl methacrylate and the residues of at least one other monomer. In yet another embodiment, the DRA can be a copolymer comprising repeating units of 2-ethylhexyl methacrylate monomers and butyl acrylate monomers. In still another embodiment, the DRA can be a homopolymer comprising repeating units of 2-ethylhexyl methacrylate.

In at least one other specific embodiment, the DRA can have the residues of at least one monomer having a heteroatom. The term “heteroatom” includes any atom that is not a carbon or hydrogen atom. Specific examples of heteroatoms include, but are not limited to, oxygen, nitrogen, sulfur, phosphorous, and/or chlorine atoms. In one embodiment, the DRA can have at least about 10 percent, at least about 25 percent, or at least 50 percent of the residues of monomers having at least one heteroatom. Additionally, the heteroatom can have a partial charge. The term “partial charge” refers to an electric charge, either positive or negative, having a value of less than 1.

Useful surfactants can include at least one high HLB anionic or nonionic surfactant. The “HLB number” refers to the hydrophile-lipophile balance of a surfactant in an emulsion. The HLB number is determined by the methods described by W. C. Griffin in J. Soc. Cosmet. Chem., 1, 311 (1949) and J. Soc. Cosmet. Chem., 5, 249 (1954), which are incorporated herein by reference. As used herein, the term “high HLB” shall denote an HLB number of 7 or more. The HLB number of surfactants for use with forming the reaction mixture can be at least about 8, at least about 10, or at least 12. In one particular embodiments, the surfactant selected can have an HLB number of about 7 to about 10.

Exemplary high HLB anionic surfactants include, but are not limited to, high HLB alkyl sulfates, alkyl ether sulfates, dialkyl sulfosuccinates, alkyl phosphates, alkyl aryl sulfonates, and sarcosinates. Suitable examples of commercially available high HLB anionic surfactants include, but are not limited to, sodium lauryl sulfate (available as RHODAPON LSB from Rhodia Incorporated, Cranbury, N.J.), dioctyl sodium sulfosuccinate (available as AEROSOL OT from Cytec Industries, Inc., West Paterson, N.J.), 2-ethylhexyl polyphosphate sodium salt (available from Jarchem Industries Inc., Newark, N.J.), sodium dodecylbenzene sulfonate (available as NORFOX 40 from Norman, Fox & Co., Vernon, Calif.), and sodium lauroylsarcosinic (available as HAMPOSYL L-30 from Hampshire Chemical Corp., Lexington, Mass.).

Other useful high HLB nonionic surfactants include, but are not limited to, high HLB sorbitan esters, PEG fatty acid esters, ethoxylated glycerine esters, ethoxylated fatty amines, ethoxylated sorbitan esters, block ethylene oxide/propylene oxide surfactants, alcohol/fatty acid esters, ethoxylated alcohols, ethoxylated fatty acids, alkoxylated castor oils, glycerine esters, linear alcohol ethoxylates, and alkyl phenol ethoxylates. Suitable examples of commercially available high HLB nonionic surfactants include, but are not limited to, nonylphenoxy and octylphenoxy poly (ethyleneoxy) ethanols (available as the IGEPAL CA and CO series, respectively from Rhodia, Cranbury, N.J.), C8 to C18 ethoxylated primary alcohols (such as RHODASURF LA-9 from Rhodia Inc., Cranbury, N.J.), C11 to C15 secondary-alcohol ethoxylates (available as the TERGITOL 15-S series, including 15-S-7, 15-S-9, 15-S-12, from Dow Chemical Company, Midland, Mich.), polyoxyethylene sorbitan fatty acid esters (available as the TWEEN series of surfactants from Uniquema, Wilmington, Del.), polyethylene oxide (25) oleyl ether (available as SIPONIC Y-500-70 from Americal Alcolac Chemical Co., Baltimore, Md.), alkylaryl polyether alcohols (available as the TRITON X series, including X-100, X-165, X-305, and X-405, from Dow Chemical Company, Midland, Mich.).

In one embodiment, the initiation system for use in the above-mentioned reaction mixture can be any suitable system for generating free radicals necessary to facilitate emulsion polymerization. Possible initiators include, but are not limited to, persulfates (e.g., ammonium persulfate, sodium persulfate, potassium persulfate), peroxy persulfates, and peroxides (e.g., tert-butyl hydroperoxide) used alone or in combination with one or more reducing components and/or accelerators. Possible reducing components include, but are not limited to, bisulfites, metabisulfites, ascorbic acid, erythorbic acid, and sodium formaldehyde sulfoxylate. Possible accelerators include, but are not limited to, any composition containing a transition metal having two oxidation states such as, for example, ferrous sulfate and ferrous ammonium sulfate. Alternatively, known thermal and radiation initiation techniques can be employed to generate the free radicals. In another embodiment, any polymerization and corresponding initiation or catalytic methods known by those skilled in the art may be used in the present invention. For example, when polymerization is performed by methods such as addition or condensation polymerization, the polymerization can be initiated or catalyzed by methods such as cationic, anionic, or coordination methods.

When water is used to form the above-mentioned reaction mixture, the water can be purified water such as distilled or deionized water. However, the continuous phase of the emulsion can also comprise polar organic liquids or aqueous solutions of polar organic liquids, such as those listed below.

The reaction mixture optionally can include one or more buffer. Suitable buffers can be or include any known buffer that is compatible with the initiation system such as, for example, carbonate, phosphate, and/or borate buffers.

The reaction mixture optionally can include one or more hydrate inhibitors. The hydrate inhibitor can be a thermodynamic hydrate inhibitor such as, for example, an alcohol and/or a polyol. In one embodiment, the hydrate inhibitor can comprise one or more polyhydric alcohols and/or one or more ethers of polyhydric alcohols. Suitable polyhydric alcohols include, but are not limited to, monoethylene glycol, diethylene glycol, triethylene glycol, monopropylene glycol, and/or dipropylene glycol. Suitable ethers of polyhydric alcohols include, but are not limited to, ethylene glycol monomethyl ether, diethylene glycol monomethyl ether, propylene glycol monomethyl ether, and dipropylene glycol monomethyl ether.

Generally, the hydrate inhibitor can be any composition that when mixed with distilled water at a 1:1 weight ratio produces a hydrate inhibited liquid mixture having a gas hydrate formation temperature at 2,000 psia that is lower than the gas hydrate formation temperature of distilled water at 2,000 psia by an amount in the range of from about 10 to about 150° F., in the range of from about 20 to about 80° F., or in the range of from 30 to 60° F. For example, monoethylene glycol qualifies as a hydrate inhibitor because the gas hydrate formation temperature of distilled water at 2,000 psia is about 70° F., while the gas hydrate formation temperature of a 1:1 mixture of distilled water and monoethylene glycol at 2,000 psia is about 28° F. Thus, monoethylene glycol lowers the gas hydrate formation temperature of distilled water at 2,000 psia by about 42° F. when added to the distilled water at a 1:1 weight ratio. It should be noted that the gas hydrate formation temperature of a particular liquid may vary depending on the compositional make-up of the natural gas used to determine the gas hydrate formation temperature. Therefore, when gas hydrate formation temperature is used herein to define what constitutes a “hydrate inhibitor,” such gas hydrate temperature is presumed to be determined using a natural gas composition containing 92 mole percent methane, 5 mole percent ethane, and 3 mole percent propane.

In forming the reaction mixture, the monomer, water, the at least one surfactant, and optionally the hydrate inhibitor, can be combined under a substantially oxygen-free atmosphere that is maintained at less than about 1,000 ppmw oxygen or less than about 100 ppmw oxygen. The oxygen-free atmosphere can be maintained by continuously purging the reaction vessel with an inert gas such as nitrogen and/or argon. The temperature of the system can be kept at a level from the freezing point of the continuous phase up to about 60° C., in the range of from about 0 to about 45° C., or in the range of from 0 to 30° C. The system pressure can be maintained in the range of from about 5 to about 100 psia, in the range of from about 10 to about 25 psia, or about atmospheric pressure. However, higher pressures up to about 300 psia can be necessary to polymerize certain monomers, such as diolefins.

Next, a buffer can be added, if required, followed by addition of the initiation system, either all at once or over time. The polymerization reaction is carried out for a sufficient amount of time to achieve at least about 90 percent conversion by weight of the monomers. Typically, this time period is in the range of from between about 1 to about 10 hours, or in the range of from 3 to 5 hours. During polymerization, the reaction mixture can be continuously agitated.

The emulsion polymerization reaction yields a latex composition comprising a dispersed phase of solid particles and a liquid continuous phase. The latex can be a stable colloidal dispersion comprising a dispersed phase of high molecular weight polymer particles and a continuous phase comprising water. The colloidal particles can comprise in the range of from about 10 to about 60 percent by weight of the latex, or in the range of from 40 to 50 percent by weight of the latex. The continuous phase can comprise water, the high HLB surfactant, the hydrate inhibitor (if present), and buffer as needed. Water can be present in the range of from about 20 to about 80 percent by weight of the latex, or in the range of from about 40 to about 60 percent by weight of the latex. The high HLB surfactant can comprise in the range of from about 0.1 to about 10 percent by weight of the latex, or in the range of from 0.25 to 6 percent by weight of the latex. As noted in the table above, the buffer can be present in an amount necessary to reach the pH required for initiation of the polymerization reaction and is initiator dependent. Typically, the pH required to initiate a reaction is in the range of from 6.5 to 10.

When a hydrate inhibitor is employed in the reaction mixture, it can be present in the resulting latex in an amount that yields a hydrate inhibitor-to-water weight ratio in the range of from about 1:10 to about 10:1, in the range of from about 1:5 to about 5:1, or in the range of from 2:3 to 3:2. Alternatively, all or part of the hydrate inhibitor can be added to the latex after polymerization to provide the desired amount of hydrate inhibitor in the continuous phase of the latex.

In one embodiment, the DRA of the dispersed phase of the latex can have a weight average molecular weight (Mw) of at least about 1×106 g/mol, at least about 2×106 g/mol, or at least 5×106 g/mol. The colloidal particles of DRA can have a mean particle size of less than about 10 microns, less than about 1,000 nm (1 micron), in the range of from about 10 to about 500 nm, or in the range of from 50 to 250 nm. At least about 95 percent by weight of the colloidal particles can be larger than about 10 nm and smaller than about 500 nm. At least about 95 percent by weight of the particles can be larger than about 25 nm and smaller than about 250 nm. The continuous phase can have a pH in the range of from about 4 to about 10, or in the range of from about 6 to about 8 and contains few if any multi-valent cations.

In yet another embodiment, the DRA can have at least about 10,000, at least about 25,000, or at least 50,000 repeating units selected from the residues of the above-mentioned monomers. In one embodiment, the DRA can comprise less than 1 branched unit per monomer residue repeating unit. Additionally, the DRA can comprise less than 1 linking group per monomer residue repeating unit. Furthermore, the DRA can exhibit little or no branching or crosslinking. Also, the DRA can have perfluoroalkyl groups in an amount in the range of from about 0 to about 1 percent based on the total number of monomer residue repeating units in the DRA.

A method for using DRAs for reversed emulsion matrix acidizing applications and acid fracturing applications is also provided herein. The method can include introducing a treatment fluid into a wellbore, where the treatment fluid includes 1 ppm to 10 wt % of one or more oil-soluble DRAs having a molecular weight of at least 200,000. The composition is a two-phase fluid with a hydrophobic continuous phase and a dispersed water phase, wherein the water phase contains one or more reactive acids with a pH of less than 4. The treatment fluid can be introduced into a formation for scale removal, fracturing acidizing, matrix acidizing and/or filter cake removal. The two-phase system can contains a hydrophobic phase with a volume fraction between 5% to 60%, balanced with a water dispersed phase containing reactive acid. A preferred volume fraction for the hydrophobic phase is between 10% to 40%, and a more preferred volume fraction for the hydrophobic phase is between 20% to 35%. In certain embodiments, the volume fraction for the hydrophobic phase can range from a low of about 5%, 10%, 15% or 18% to a high of about 20%, 35%, 45%, or 60 wt %,

The reactive acids can be at least one of the following: hydrochloric acid; hydrofluoric acid; acetic acid; formic acid; citric acid; chelating agents; glycolic acid; and sulfamic acid. For example, the reactive acid can be a HCl solution with concentration between 1% and 38%, preferred between 5% to 30%.

In one or more embodiments above or elsewhere herein, the treatment fluid can further include at least one of the following: fresh water, a brine, an inorganic salt, a corrosion inhibitor, an organic salt, an iron control agent, an H2S scavengers, an surfactant; a breaker; a fluid loss control additive; a scale inhibitor; an asphaltene inhibitor; a paraffin inhibitor, a defoamer; a solvent; a mutual solvent; a particulate diverter; a chelating agent. In one or more embodiments, the water of the water phase can be recycled water, grey water, black water, reclaimed water, brine or fresh water.

In one or more embodiments above or elsewhere herein, the hydrophobic phase is made from one of the following: diesel, kerosene, fuel oil, crude oil condensates, petroleum distills, mineral oils, crude oil, liquid paraffin.

In one or more embodiments above or elsewhere herein, the oil-soluble DRA has a molecular weight between 100,000 and 20 million, preferably 1 million and 5 million, and is selected from the group consisting of polyvinyl chloride, polymethylmethacrylate, polyalphaolefin, nonionic polyacrylamide, polyacrylamide esters, polyesters, polyacrylic acid, polystyrene, polydimethylsiloxane, polymeric surfactants, Vinyl Acetate Copolymers, Aromatic Polyisobutylene Succinimides, Styrene and vinyl acetate (SVA) copolymers, Aminated copolymer and ethylene-vinyl acetate copolymers (EVA), Modified Maleic Anhydride Co-polymers, PEAA graft co-polymer (PEAA-g-VA), Anhydride and esters of n-alkyl alcohols based Polymeric Additives, Ethylene Acrylic Alkyl Ester Copolymer.

In one or more embodiments above or elsewhere herein, the DRA concentrate is delivered in one of the following forms: slurry, emulsion, solution concentrate.

In one or more embodiments above or elsewhere herein, the DRA can be a polyalphaolefin polymer with an average molecular weight of more than 500,000, preferably more than a million, more preferable over 3 million.

In one or more embodiments above or elsewhere herein, the polyalphaolefin polymer product is delivered in a slurry form with at least one of the following chemicals: straight alcohols, branched alcohols, glycols, water, surfactant, dispersant agent, weighting agent, inorganic salt, organic salt, brine, saturated hydrocarbons, unsaturated hydrocarbons, aromatic hydrocarbons, viscosifier, biocide. The preferred solid content for the polyalphaolefin slurry is between 10% to 70 wt %, a preferred range is between 20% to 50 wt %, and more preferred range is between 20% to 30 wt %.

In one or more embodiments, the polar solvent can contain propylene glycol in amount of 5% to 80 wt %, a preferred range for propylene glycol is between 15% to 35 wt %. The polar solvent can also contain an iso-octanol with a range of 10% to 80 wt %, and a preferred range for ISO-Octanol is between 40% to 50 wt %.

In one or more embodiments above or elsewhere herein, the polyalphaolefin powder has an average diameter of about 1.0 micrometer to about 1000 micrometer. A preferred range is about 10 micrometers to about 100 micrometers.

In one or more embodiments above or elsewhere herein, the oil soluble DRA is delivered in a concentrated emulsion form containing a DRA containing dispersed hydrophobic phase and a continuous hydrophilic phase. The hydrophilic phase contains at least one of the following: water, inorganic salt, organic salt, emulsifier, alcohols, glycols; and hydrophobic phase contains at least one of the following: saturated hydrocarbons, unsaturated hydrocarbons, aromatic hydrocarbons, diesel, petroleum distills, liquid petroleum products, oil-soluble solvents.

In one or more embodiments above or elsewhere herein, the DRA is a polyalphaolefin concentrate solution in the hydrophobic phase between 0.1% to 50% by weight, preferable between 5 to 10% by weight.

In one or more embodiments above or elsewhere herein, the emulsifier is selected from at least one of the following surfactants with a Hydrophilic-Lipophilic Balance (HLB) value higher than 7: amides, glycol esters, PEG esters, sorbitol esters, alkyl polyethoxylates, nonyl phenol ethoxylates, alcohol ethoxylates, alcohol EO/PO polymers, EO/PO blocked copolymers, betaines, sultaines, alkyl sulfates, alpha olefin sulfonates, sulfosuccinates, phosphate esters, amine oxides.

A more preferred surfactant is a nonyl phenol ethoxylate with a concentration between 0.1% to 10%, preferably 0.5% to 2%.

In one or more embodiments above or elsewhere herein, the DRA product is delivered in a homogeneous concentrated liquid form in one or more nonpolar solvents. The nonpolar solvents can be selected from at least one of the flowing: diesel, kerosene, fuel oil, petroleum condensates, petroleum distills, mineral oils, crude oil, liquid paraffin, aromatic hydrocarbons, and long chain alcohols with carbon chain longer than 6, vegetable oil, or mineral oil. The preferred nonpolar solvent is a liquid paraffin.

In one or more embodiments above or elsewhere herein, the DRA is a polyalphaolefin with concentration between 0.1% to 10 wt %, preferably between 1% to 2 wt %.

### Examples

The foregoing discussion can be further described with reference to the following non-limiting examples.

### Example 1: Drag Reducing Test of a Water-In-Oil Emulsion

A hydrocarbon/oil phase was prepared by dissolving Span® 80 (0.5% by volume) and various amounts of drag reducing agent XK30 into diesel and mixed for 30 mins. The water phase was prepared by mixing KCl (4% by weight) into water. A water-in-oil emulsion was prepared by mixing 30% of the oil phase with 70% of the water phase for 10 mins to obtain a homogeneous emulsion.

### Test Equipment Setup:

Equipment set up: 1: Compressed nitrogen tank, 2: Pressure buffering tank, 3: Dilution tank, 4: Safety valve, 5: Pressure release valve, 6; Pump, 7: fluid recovery tank; 8: Control switch valve, A: Flow meter, B/C/D: Pressure sensor.

### Test Method:

The reversed emulsion was tested according to China GB standard SY/T6578-2016. Results are shown in Table 1 below.

TABLE 1
Drag reducing test of a water-in-oil emulsion.

| Drag Reducing Agent | Friction |
|---|---|
| Loading (ppm) | Reduction |
| 10 | 19.3% |
| 100 | 36.2% |
| 200 | 57.9% |
| 300 | 62.7% |

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, meaning the values take into account experimental error, machine tolerances and other variations that would be expected by a person having ordinary skill in the art.

The foregoing has also outlined features of several embodiments so that those skilled in the art can better understand the present disclosure. Those skilled in the art should appreciate that they can readily use the present disclosure as a basis for designing or modifying other methods or devices for carrying out the same purposes and/or achieving the same advantages of the embodiments disclosed herein. Those skilled in the art should also realize that such equivalent constructions do not depart from the spirit and scope of the present disclosure, and that they can make various changes, substitutions, and alterations herein without departing from the spirit and scope of the present disclosure, and the scope thereof is determined by the claims that follow.

To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

What is claimed is:

1. A treatment fluid for downhole operations, comprising:
1 ppm to 10 wt %, based on the total weight of the treatment fluid, of one or more types of oil-soluble DRAs having a weight average molecular weight (Mw) of greater than 200,000;
one or more hydrocarbons;
water; and
one or more reactive acids with a pH of less than 4,
wherein the treatment fluid is a two-phase fluid with a hydrophobic continuous phase and a dispersed water phase, the hydrophobic continuous phase comprising the DRA and the hydrocarbon, and the water phase comprising the water and the one or more reactive acids.

2. The fluid of claim 1, wherein the treatment fluid is introduced into the formation using one of the following operations: scale removal, fracturing acidizing, matrix acidizing, filter cake removal, or combinations thereof.

3. The fluid of claim 1, wherein the two-phase fluid contains an hydrophobic phase with a volume fraction between 5% to 60%, balanced with a water dispersed phase containing reactive acid.

4. The fluid of claim 1 wherein the reactive acids are selected from the group consisting of: hydrochloric acid; hydrofluoric acid; acetic acid; formic acid; citric acid; chelating agents; glycolic acid; and sulfamic acid.

5. The fluid of claim 4, wherein the reactive acid is an HCl solution with a concentration between 1% and 38%.

6. The fluid of claim 1, further comprising at least one of the following: fresh water, brine, inorganic salt, corrosion inhibitor, organic salt, iron control agent, H2S scavenger, surfactant, breaker, fluid loss control additive, scale inhibitor, asphaltene inhibitor, paraffin inhibitor, defoamer, solvent, mutual solvent, particulate diverter, and chelating agent.

7. The fluid of claim 1, wherein the hydrophobic phase is derived from one of the following:
diesel, kerosin, crude oil condensates, petroleum distills, mineral oils, crude oil, and liquid paraffin.

8. The fluid of claim 1, wherein the oil-soluble DRA has a molecular weight between 100,000 and 20 million, and is selected from the group consisting of polyvinyl chloride, polymethylmethacrylate, polyalphaolefin, nonionic polyacrylamide, polyacrylamide esters, polyesters, polyacrylic acid, polystyrene, polydimethylsiloxane, polymeric surfactants, Vinyl Acetate Copolymers, Aromatic Polyisobutylene Succinimides, Styrene and vinyl acetate (SVA) copolymers, Aminated copolymer and ethylene-vinyl acetate copolymers (EVA), Modified Maleic Anhydride Co-polymers, PEAA graft co-polymer (PEAA-g-VA), Anhydride and esters of n-alkyl alcohols based Polymeric Additives, and Ethylene Acrylic-Alkyl Ester Copolymer.

9. The fluid of claim 8, wherein the types of the oil-soluble DRA is a slurry, emulsion, or solution concentrate.

10. The fluid of claim 8, wherein the oil soluble DRA is a polyalphaolefin polymer with an average molecular weight of 500,000 to 3 million.

11. The fluid of claim 10, wherein the polyalphaolefin polymer product is delivered in a slurry form with at least one of the following: one or more straight alcohols, one or more branched alcohols, one or more glycols, water, one or more surfactants, one or more dispersant agents, one or more weighting agents, one or more inorganic salts, one or more organic salts, brine, one or more saturated hydrocarbons, one or more unsaturated hydrocarbons, one or more aromatic hydrocarbons, one or more viscosifiers, and one or more biocides.

12. The fluid of claim 11, wherein the slurry form has a solids content of about 10 wt % to about 70 wt %.

13. The fluid of claim 11, wherein the slurry form contains about 5 wt % to about 80 wt % of propylene glycol.

14. The fluid of claim 11, wherein the slurry form contains about 10 wt % to about 80 wt %, of iso-octanol.

15. The fluid of claim 11, wherein the polyalphaolefin polymer has an average diameter of about 1.0 micrometer to about 1,000 micrometer. A preferred range is between 10 μm and 100 uM.

16. The fluid of claim 1, wherein the oil soluble DRA is delivered in a concentrated emulsion form containing a DRA containing dispersed hydrophobic phase and a continuous hydrophilic phase that contains at least one of the following: water, inorganic salt, organic salt, emulsifier, alcohols, and glycols; and a hydrophobic phase that contains at least one of the following: saturated hydrocarbons, unsaturated hydrocarbons, aromatic hydrocarbons, diesel, petroleum distills, liquid petroleum products, and oil-soluble solvents.

17. The fluid of claim 16, wherein the oil soluble DRA is a polyalphaolefin concentrate in the hydrophobic phase between 0.1% to 50% by weight.

18. The fluid of claim 16, further comprising an emulsifier selected from at least one of the following surfactants with a Hydrophilic-Lipophilic Balance (HLB) value higher of about 7 or more: one or more amides, glycol esters, PEG esters, sorbitol esters, alkyl polyethoxylates, nonyl phenol ethoxylates, alcohol ethoxylates, alcohol EO/PO polymers, EO/PO blocked copolymers, betaines, sultaines, alkyl sulfates, alpha olefin sulfonates, sulfosuccinates, phosphate esters, and amine oxides.

19. The fluid of claim 18, wherein the emulsifier comprises about 0.1 wt % to about 10 wt % nonyl phenol ethoxylate.

20. The fluid of claim 9, wherein the DRA product is delivered in an homogeneous concentrated liquid form in nonpolar solvent selected from at least one of the flowing: diesel, kerosin, petroleum condensates, petroleum distills, mineral oils, crude oil, liquid paraffin, aromatic hydrocarbons, and long chain alcohols with carbon chain longer than 6, and vegetable oil.
